(19) United States
(12) Patent Application Publication
(10) Pub. No.: US 2019/0377123 A1
(43) Pub. Date: Dec. 12, 2019

(54) PLATE-SHAPED OPTICAL ELEMENT FOR COUPLING OUT LIGHT

(71) Applicant: temicon GmbH, Dortmund (DE)

(72) Inventors: Volkmar Boerner, Freiburg (DE); Dr. Oliver Humbach, Dortmund (DE)

(21) Appl. No.: 16/065,269

(22) PCT Filed: Dec. 23, 2016
(86) PCT No.: PCT/EP2016/082575

§ 371 Date: Jun. 22, 2018

(30) Foreign Application Priority Data
Dec. 23, 2015 (DE) 10 2015 122 768.1

(51) Int. Cl. F21V 8/00; G02B 1/118; E06B 3/67

(52) U.S. Cl. CPC G02B 6/0036; G02B 6/0045; E06B 3/6715; G02B 1/118; G02B 6/0055

(57) ABSTRACT

A description is given of an optical element (10) having a transparent, plate-shaped optical waveguide (12), having a surface structure having elevations (22) and/or depressions for coupling out light. A transparent cover plate (14) is arranged parallel at a distance from the optical waveguide (12). In order to obtain an element which, firstly, is intended to serve for coupling out light and, secondly, can be used as a transparent element e.g. for a window, a reflection-reducing nanostructure (30) having a plurality of elevations (34) is provided on at least one surface of the cover plate (14) and/or on a surface (20) of the optical waveguide (12).

The invention relates to an optical element. In particular, the invention relates to an optical element having a transparent, plate-shaped optical waveguide with a surface structure having elevations and/or depressions for coupling out light.

Transparent, plate-shaped optical waveguides with a surface structure for coupling out light are generally known. They can serve, for example, to guide laterally coupled light within the optical waveguide and then couple out said light on elevations of the surface structure. In this way, a desired flat lighting effect can be attained.

WO 2011/067719 A1 describes a window element that is capable of emitting light. An optical waveguide is provided to guide the light of a light source through total reflection. Scattering structures or outcoupling structures are arranged on the surface of the optical waveguide in order to couple out light from the optical waveguide. The outcoupling structures are disposed between the optical waveguide and a pane of glass so that, between the elevations, regions between the optical waveguide and the pane of glass are formed where they are not in contact. The outcoupling structures can serve as spacers between the optical waveguide and the pane of glass. A further pane of glass can be provided on the opposite side of the optical waveguide.

DE 199 15 209 A1 describes a device for backlighting of a flat display with an optical waveguide plate that has trapezoidal or rectangular microstructures on one side surface, while a reflector is disposed on the other side surface. The optical waveguide plate consists of transparent material, preferably PMMA. On a narrow side, a rod-shaped light source is disposed from which light is coupled into the optical waveguide plate and spreads under total reflection in the optical waveguide plate. The trapezoidal or rectangular microstructures serve to couple out the light from the optical waveguide plate. In one embodiment, a sawtooth film is disposed on the side surface and has a structure consisting of microprisms on its side facing the optical waveguide plate, said structure serving to divert the light coupled out from the optical waveguide plate by the rectangular or trapezoidal structures toward a display.

It can be considered as an object of the invention to propose an optical element that, on the one hand, serves to couple out light and, on the other hand, can be used as a transparent element, for example for a window.

This object is achieved by an optical element according to claim 1. Dependent claims refer to advantageous embodiments of the invention.

According to the invention, a plate-shaped optical waveguide consisting of a transparent material, for example glass or a transparent plastic, is provided. A surface structure with a number of elevations and/or depressions for coupling out light is provided on at least one side of the plate-shaped optical waveguide. A wide variety of shapes of, for example, regularly disposed or stochastically distributed elevations and/or depressions can serve as outcoupling structures, said elevations and/or depressions being suitable for coupling out light from the optical waveguide that would otherwise be subject to the total reflection on the surface.

According to the invention, a transparent cover plate is disposed parallel to the optical waveguide, which also consists of, for example, glass or a transparent plastic. The cover plate is located at a slight distance from the optical waveguide so that a free region is formed therebetween. Preferably, the distance is large enough so that the guiding of the light and the coupling out of the light on the surface structure are not substantially influenced. The cover plate serves to protect the surface structure, for example from soiling or mechanical damage.

According to the invention, a reflection-reducing nanostructure with a plurality of elevations and/or depressions is provided at least on one surface of the optical waveguide and/or on one surface of the cover plate, preferably on the surface of the cover plate facing the optical waveguide and/or on the surface of the optical waveguide facing the cover plate.

This prevents the formation of disruptive reflections. These play a role in particular when the optical element is used as a transparent construction element, for example as a window pane. Disruptive reflections are significantly decreased, and in the ideal case completely avoided, by the reflection-reducing nanostructure, in particular on one or preferably both of the boundary surfaces that are opposite each other of the space formed between the cover plate and the optical waveguide.

For use, for example, as a window pane, the optical element preferably covers a large area, with edge lengths of, for example, more than 10 cm each, preferably more than 30 cm. Much greater dimensions of, for example, more than 100 cm edge lengths are also possible.

The reflection-reducing nanostructure provides a modulation of the surface that can be, for example, regular or also stochastic. The nanostructure formed in this manner has the effect of being anti-reflective for a broad spectrum of light. On a boundary surface with such a nanostructure, there is no abrupt but rather a gradual refractive index change. For example, a suitable nanostructure can be formed from elevations and/or depressions with a height of 500 nm or less. Structure heights of 150-400 nm are preferred. The individual elevations preferably have an average distance to each other of 100-500 nm, further preferably 100-300 nm. The modulation of the surface can be shaped, for example, as a cross lattice or a line grating structure. The structure profile is preferably not rectangular but rather rounded.

The reflection-reducing nanostructure is preferably provided both on the surface of the cover plate facing the optical waveguide and on the surface of the optical waveguide facing the cover plate. In this way, a particularly good suppression of reflections on both boundary surfaces is achieved.

According to one development of the invention, the cover plate is held at a distance from the optical waveguide by a plurality of spacers distributed over the area. The spacers can, for example, have a height of 2 μm to 2 mm, preferably 30 μm to 1 mm, particularly preferably 50-300 μm. Small spacers are preferred with a height of 200 μm or less, further preferred 100μ or less. The shape of the spacers can, for example, be cylindrical, conical or frusto-conical, with various shapes of the respective base area, for example rectangular, trapezoidal, round, elliptical, etc. The spacers are preferably narrowly designed so that the ratio of the height to the maximum lateral dimension is 2:1 or greater. The spacers can be disposed on the cover plate or on the optical waveguide and in particular also on the elevations and/or in the depressions of the surface structure of the optical waveguide. Various materials can be considered for the spacers, for example varnish or thermoplastics. For example, they can be formed integrally with the optical waveguide and/or with the cover plate, for example with the plastic injection molding method. The spacers can also, however, be formed separately from the material of the cover plate and/or of the optical waveguide, for example as a varnish layer, in particular consisting of a UV-curable varnish.

With the spacers preferably distributed over the area, it is achieved that a distance between the optical waveguide and the cover plate that is as constant as possible and preferably very small remains. With the distance, it can be achieved that the cover plate does not hinder the guiding of light and the coupling out of light on the surface structure, but rather a boundary surface to the free region lying between the cover plate and the optical waveguide continues to be present here that, for example, can be filled with air.

As an alternative to separate spacers, however, elevations of the surface structure provided for coupling out light can also serve to hold the cover plate at a distance from the optical waveguide. The optical waveguide and the cover plate are hereby not in contact in the regions between the individual elevations. In principle, the optical waveguide and the cover plate can be disposed loosely on each other or, however, be firmly surface-bonded and fixed to each other. It can be useful to adjust the angular spectrum of the light distribution in the optical waveguide in order to keep light transfer into the cover plate to a minimum. A transfer of light into the cover plate is only slightly harmful for the functionality of the optical element, since light transferring over the contact surfaces is not deflected and is therefore not coupled out via the outward-facing side of the cover plate. However, too much light conducted in the cover plate can lead to any soilings on the surface of the cover plate becoming more clearly visible, since light conducted in the cover plate can be coupled out via these soilings.

According to one development of the invention, the outcoupling structure can be formed by a surface structure of the optical waveguide having elevations and/or depressions with a height of, for example, 2-500 μm, preferably 5-250 μm. Elevations can hereby be formed integrally with the rest of the material of the optical waveguide, for example with a stamping of the surface. The elevations and/or depressions can also, however, be formed as, or respectively in, elements arranged firmly on the surface of the optical waveguide from a different material than the optical waveguide, for example by, or respectively in, a structured varnish layer formed on the surface. Preferred values for the structure height of the surface structure are 30-100 μm, particularly preferably 40-80 μm. The proportional area coverage of the elevations or respectively depressions of the outcoupling structure is preferably small relative to the overall area of the optical waveguide and is, for example, less than 5%, preferably 2% or less. The arrangement can be regular but is preferably stochastic.

While it is possible for the reflection-reducing nanostructure on the surface of the optical waveguide to only be provided between the elevations and/or depressions of the surface structure, it is preferred that the nanostructure is also present on the elevations or respectively in the depressions. In this way, reflections are also avoided at these locations.

According to one development of the invention, a mirror coating can be provided in the contact region between the optical waveguide and the spacers. A mirror coating can be achieved, for example, by a metal layer. The mirror coating can ensure that the reflective characteristics on the surface of the optical waveguide are not changed despite the contact with the spacer. In order to only impede the transparent characteristic of the optical waveguide as slightly as possible, the mirror coating is preferably disposed point-wise and intermittently and is only provided in the region of the contact between the spacers and the optical waveguide as well as slightly exceeding this as appropriate.

In one advantageous embodiment of the invention, an adhesive layer or an activation of the surface is provided in the contact region between at least one, preferably all of the spacers and the cover plate in order to produce a fixed connection between the cover plate and the optical waveguide. Particularly preferably, the elevations of the surface structure for coupling out light serve hereby as spacers. The adhesion can in principle be both a point-by-point application of an adhesive and a flat adhesion, in particular over the entire surface of an elevation of the surface structure for coupling out light that abuts the cover plate. An activation of the surfaces can occur, for example, by means of plasma treatment in order to achieve a particularly fixed connection.

The optical elements can be covered with a transparent cover plate on only one side. Optical elements with cover plates disposed on both sides of the optical waveguide can also be provided, wherein the surface structure serving to couple out the light can then be provided on one side or on both sides of the optical waveguide.

Furthermore, a surface structure having elevations and/or depressions for coupling out light can also be provided on each of the two sides of the optical waveguide. A transparent cover plate is hereby disposed preferably on or above each of the two surface structures. Particularly preferably, the elevations for coupling out on both sides of the optical waveguide serve as spacers for the two cover plates.

Embodiments of the invention will be described in greater detail below with reference to the drawings. In the drawings:

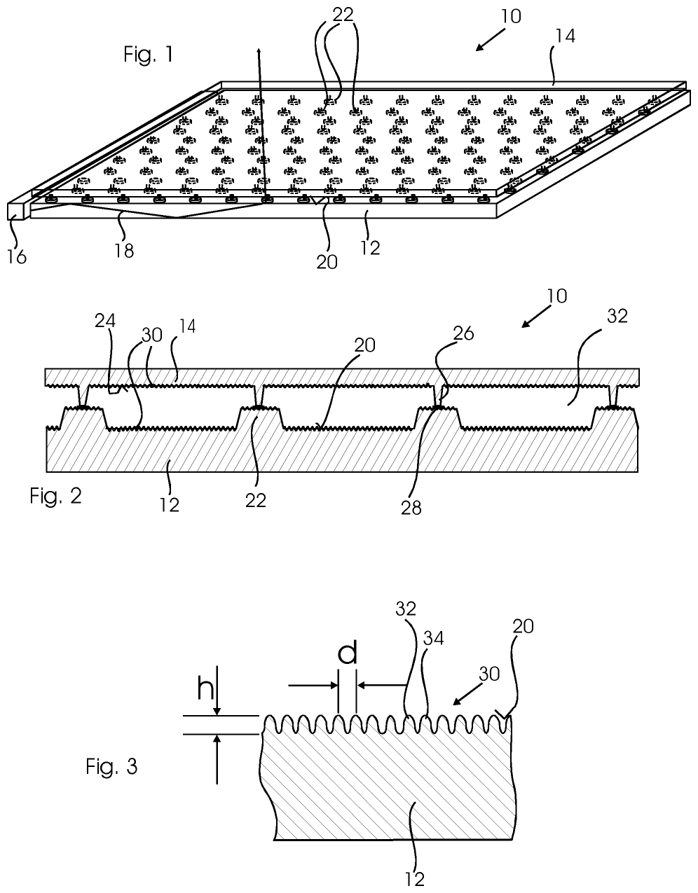

FIG. 1 shows a schematic perspective view of a first embodiment of an optical element;

FIG. 2 shows a schematic representation of a cross-section through the optical element from FIG. 1;

FIG. 3 shows a schematic, enlarged representation of a part of the surface of an optical waveguide of the optical element from FIG. 1, FIG. 2 with a nanostructure;

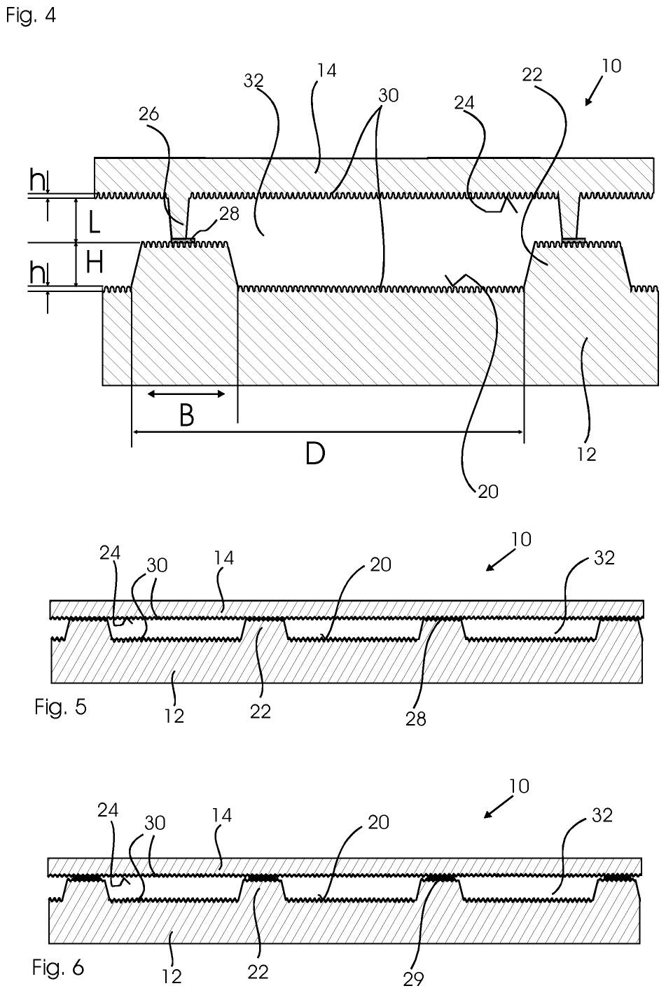

FIG. 4 shows a schematic, enlarged representation of a cross-section of the optical waveguide from FIG. 1, FIG. 2;

FIG. 5 shows a schematic representation of a cross-section through a second embodiment of an optical element having elevations for coupling out as a spacer;

FIG. 6 shows a schematic representation of a cross-section through a third embodiment of an optical element with an adhesive layer between a cover plate and the spacers;

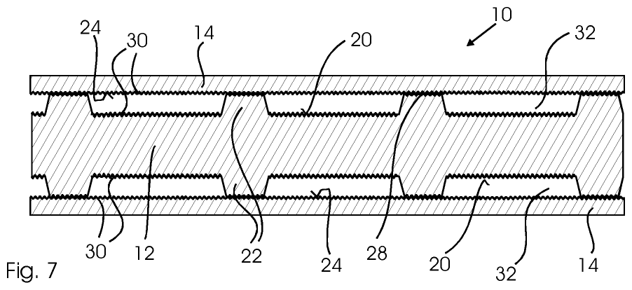

FIG. 7 shows a schematic representation of a cross-section through a fourth embodiment of an optical element with elevations for coupling out on both sides.

FIG. 1 schematically shows an embodiment of a plate-shaped optical element 10. The optical element 10 and its components in FIGS. 1-4 are only represented schematically and in particular not to scale.

The plate-shaped optical element 10 shown in FIG. 1 is a composite plate consisting of a transparent, plate-shaped optical waveguide 12 and a cover plate 14 disposed parallel at a distance therefrom. In the example represented here, the optical waveguide 12 consists of PMMA as the transparent plastic, while the cover plate 14 is a glass plate.

By means of a line-shaped light source 16 that is only schematically indicated in FIG. 1, light can be coupled into the optical waveguide 12 on a narrow side of the plate element 10, said light, as shown as an example with a beam 18, being subjected to the total reflection there and guided in the interior of the material of the optical waveguide 12.

As shown in FIG. 1, a number of elevations 22 are formed on the upper surface 20 of the optical waveguide 12 facing the cover plate 14 that form a surface structure for coupling out light from the optical waveguide 12. As shown schematically with the example of the beam 18, light is coupled out on the elevations 22 of the surface structure in the direction at a right angle to the plane of the plate element 10.

The plate element 10 is almost completely transparent in the thickness direction, i.e. at a right angle to its plane, since it is formed from the transparent cover plate and the transparent optical waveguide without a reflector or a non-transparent layer being provided. The elevations 22 of the surface structure of the optical waveguide 12 also consist of a transparent material. Accordingly, the plate-shaped optical element 10 can be used as a transparent pane, for example as a window pane.

On the other hand, the optical element 10 can also be used as a flat light source due to the described surface structure for coupling out light. In this way, for example, a window can be created that simultaneously serves as a flat light source.

FIG. 2 shows a cross-section through the optical element 10. As represented there, the elevations 22 of the surface structure are shaped as a single piece from the material of the optical waveguide 12 in the example shown, for example by stamping. The frusto-conical shape of the elevations 22 shown here is only to be understood as an example; elevations 22 in other shapes can also serve to suitably couple out light.

A free region 32 is formed between the optical waveguide 12 and the cover plate 14 disposed above it. The distance is hereby formed by spacers 26 that are disposed distributed over the area on the underside of the cover plate 14. In the example shown, the spacers 26 are each placed on the elevations 22 of the surface structure of the optical waveguide 12. In the example shown, the spacers 26 are designed narrow and frusto-conical-shaped with, for example, a round base area.

A part of the cross-section view from FIG. 2 is represented enlarged in FIG. 4. As evident there, point-shaped mirror coatings 28 are formed in each case on the surface of the optical waveguide 12, here on the elevations 22, at the locations on which the spacers 26 are placed, by applying thin metallic layers. With the mirror coatings 28 it is achieved that an undesired coupling out of light does not occur at the contact location with the spacer 26, but rather a reflection of light that strikes the location from within the material of the optical waveguide 12 occurs.

As represented in FIG. 4, the elevations 22 in the example shown have a structure height H of, for example, 50 μm. The individual elevations 22 are, as represented, disposed with a period D, i.e., for example every 100 μm or also only every 1000 μm. The density of the elevations 22 (i.e. the proportional area coverage) can be, for example, approx. 1% in the middle, wherein, however, the distribution is preferably not homogeneous, but rather a higher density is chosen with increasing distance from the light source 16 in order to attain an even coupling out of light. The structure width B of the individual elevations 22 can hereby be, for example, 50 μm. The spacers 26 have a length L of, for example, 100 μm.

A reflection-reducing nanostructure 30 is formed on each of the two boundary surfaces 20, 24 on both sides of the free region 32. In the example shown, the entire underside 24 of the cover plate 14, up until the spacers 26, has the nanostructure 30. The nanostructure 30 is also formed on the surface 20 of the optical waveguide 12, both on the elevations 22 and in the regions between the elevations 22.

The reflection-reducing nanostructure 30, which is shown schematically in more detail in FIG. 3, is a sub-wavelength structure with which a broadband elimination of reflections is achieved. This consists of small elevations in the form of nanocolumns 34 formed on the respective surface. In the example shown, these are equidistant to a period d of, for example, 200 nm. The nanocolumns 34 form a rounded profile of a structure height h of, for example, 300 nm. Due to the nanostructure, which is also known as a “moth-eye structure,” the boundary between the material of the optical waveguide 12 and the adjacent region 32 does not function as a boundary surface with an abrupt refractive index change on which reflection occurs. Instead, a gradual refractive index change results, in which light is transmitted at a right angle to the surface 20 largely without reflections.

With the nanostructure 30 applied to both sides of the free region 32, a reflection and in particular a repeated reflection is strongly diminished or even avoided so that the design of the optical element 10 as a composite plate does not considerably limit its transparency and accordingly use as, for example, a window pane.

Various methods can be used to produce the optical element 10 and its component parts. For example, as already explained, the structure of the surface 20 of the optical waveguide 12 having the elevations 22 can be formed by hot stamping with a corresponding stamping tool or, for example, also by injection molding with highly transparent plastic, for example PMMA. It is also possible to generate the elevations 22 by applying a structured varnish layer on the surface 20, which is in particular useful for large-area plate elements 10. The nanostructure 30 can also hereby already be provided in the surface of the stamping tool or of the injection molding tool or be formed in the structured varnish layer so that both the nanostructure 30 and the elevations 22 can be formed in one working step. To produce a suitable tool with the suitable negative nanostructure, for example a stamping tool, an injection mold or a pressure roll, for structuring the varnish layer, interference lithography, for example, can be used in a photoresist, wherein a suitable tool can be formed from the structure attained in the varnish, for example with electro-forming.

The nanostructure on the underside of the cover plate 14 can also be generated, for example, by stamping or by applying a nanostructured varnish layer. The spacers 26 as well as the mirror coatings 28 can be, for example, imprinted.

A further embodiment of an optical element 10 is represented in FIG. 5 in which the elevations 22 for coupling out light serve as spacers for a cover plate 14. The cover plate 14 is hereby disposed loosely abutting the elevations 22. Between the cover plate 14 and in the intermediate spaces between the elevations 22, a free region 32 is located in each case in which the cover plate 14 and the optical waveguide 12 are spaced apart from each other without touching. A reflection-reducing nanostructure 30 is formed on each of the two boundary surfaces 20, 24 on both sides of the free region 32. In addition, the nanostructure 30 can also be formed on one or both of the boundary surfaces 20, 24 in the region where the cover plate 12 is supported on the elevations 22.

In a further embodiment of an optical element 10 represented in FIG. 6, an adhesive layer 29, by means of which the cover plate 14 is connected in a surface-bonded manner with each of the elevations 22, is disposed between the cover plate 14 and the optical waveguide 12 in the region of the elevations 22 for coupling out light.

A further embodiment of a plate-shaped optical element 10 is represented in FIG. 7 in which an outcoupling structure having elevations 22 is also additionally provided on the underside of the optical waveguide 12. A cover plate 14 is disposed on the elevations 22 on both sides of the optical waveguide 12 so that coupling out light is possible on both sides of the optical element 10 and at the same time the optical waveguide 12 is protected on both sides from damage.

The embodiments shown are to be understood merely as examples and are not restrictive. Changes with respect to the exemplary embodiments shown are possible. In particular, the shapes of the surface structures shown, both the nanostructure 30 and the outcoupling structure with elevations 22, are to be understood merely as examples, as is the represented shape of the spacers 26.

1. An optical element having
a transparent, plate-shaped optical waveguide with a surface structure having at least one of elevations or depressions for coupling out light,
and a transparent cover plate that is disposed parallel at a distance to the optical waveguide,
wherein a reflection-reducing nanostructure having a plurality of elevations and/or depressions is provided at least on one surface of the cover plate and/or on one surface of the optical waveguide.

2. The optical element according to claim 1, in which
the cover plate is held at a distance from the optical waveguide by a plurality of spacers distributed over the area.

3. The optical element according to claim 2, in which
elevations of the surface structure for coupling out light serve as spacers, wherein the cover plate is held on the elevations at a distance from the optical waveguide.

4. The optical element according to claim 1, in which
the reflection-reducing nanostructure is provided at least on the surface of the cover plate facing the optical waveguide and on the surface of the optical waveguide facing the cover plate.

5. The optical element according to claim 1, in which
the elevations or depressions of the nanostructure have a height of 500 nm or less.

6. The optical element according to claim 1, in which
the elevations and/or depressions of the nanostructure have an average distance of 100-500 nm.

7. The optical element according to claim 1, in which
the elevations or depressions of the surface structure of the optical waveguide have a height of 2-500 μm.

8. The optical element according to claim 2, in which
the spacers have a height of 2-2000 μm.

9. The optical element according to claim 2, in which
the ratio of the height to the maximum lateral dimension of the spacers is 2:1 or greater.

10. The optical element according to claim 2, in which
the spacers are provided on the cover plate.

11. The optical element according to claim 2, in which
a mirror coating is provided in the contact region between the optical waveguide and at least one spacer.

12. The optical element according to claim 1, in which
the reflection-reducing nanostructure is provided on elevations and/or in depressions of the surface structure of the optical waveguide.

13. The optical element according to claim 1, in which
transparent cover plates are provided on both sides of the optical waveguide.

14. The optical element according to claim 2, in which
an adhesive layer or an activation of the surface is provided in the contact region between at least one spacer and the cover plate.

15. The optical element according to claim 1, in which
a surface structure having elevations and/or depressions for coupling out light is provided on both sides of the optical waveguide.
